(19) United States
(12) Patent Application Publication
(10) Pub. No.: US 2007/0098173 A1
(43) Pub. Date: May 3, 2007

(54) Method and arrangement for preventing a function

(76) Inventor: Timo Juhani Rajakallio, Vammala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/562,586

(22) PCT Filed: Jun. 24, 2004
(86) PCT No.: PCT/FI04/50104

§ 371 Date: Dec. 27, 2005

(30) Foreign Application Priority Data
Jun. 27, 2003 (FI) 20035109

(51) Int. Cl. H04K 1/00

(52) U.S. Cl. 380/249; 345/87; 345/172; 345/104; 380/281; 235/380

(57) ABSTRACT

The invention relates to a method, arrangement and computer program product for temporarily preventing a certain function of a device. In the method according to the invention, a function of a portable device is temporarily blocked, so that in the device there is received a blocking key that blocks a certain function, and that the received blocking key is activated in the device in order to prevent a certain function. By means of the blocking key, there is temporarily blocked a given undesirable function of the device for the duration, until there is received an unblocking key, and by activating the unblocking key the blocked function is released to function normally.

The invention relates to a method and arrangement for temporarily preventing a certain function of a device.

Portable devices have many different functions. For instance a typical mobile phone device can, in addition to ordinary telephone functions, be used for SMS, short message services, or for more versatile MMS, multimedia messaging services. By means of the WAP, wireless application protocol, the devices can be used for establishing a wireless connection to the Internet, email or external databases. Moreover, the device may include a stationary, integrated radio set or a terminal, In which a separate radio set can be connected. In addition, more and more attention is nowadays paid to the sound production and sound quality of the devices, and several devices are provided with auxiliary facilities in order to make the produced sound environment better and more versatile. Most advanced devices have integrated digital cameras whereby image or video image can be recorded in a digital form. The images can be viewed by the device itself, and they can be transmitted to other devices along routes known as such.

In addition to the basic functions, it is possible to add in the devices various program applications, whereby auxiliary functions and features are obtained therein. When the functions become more versatile and the various possibilities of usage are increased, the devices are all the more generally used both because of their basic functions and owing to the services and advantages obtained by the auxiliary features. However, there also are several locations and situations where the use of portable electronic devices is forbidden. For example, in an airplane the electromagnetic radiation transmitted or received by the devices may disturb the operation of the electronic devices or meters of the airplane. Consequently, for safety reasons the use of mobile phones is completely forbidden in airplanes. Another location where electromagnetic radiation may disturb sensitive electronic devices and thus cause problems is a hospital. Hospitals have wards where all electronic devices must be completely shut off.

In addition to hazardous situations, electronic devices may for instance disturb the environment because of their sounds. Normally it would be polite to attenuate or completely shut off loud devices for example in a church, in a theater, in a meeting or in another situation where they might interfere with people's concentration in the main issue at hand. Typically in all above mentioned situations, the users of electronic devices, such as mobile phones, are asked to switch the power off. Typically this is reminded both orally and in writing, but the final operation of switching the power off is left for the responsibility of the user, and it is impossible to completely control how the request is fulfilled. Hazardous situations and interference caused by human errors and forgetfulness occur every now and then.

As camera phones and similar recording devices become more popular, the use of these devices also is forbidden in situations where it is not allowed to take photographs or shoot film, for instance in performances and various exhibitions. In addition, small devices provided with cameras also constitute a threat for industry, because now it is much easier and more inconspicuous to take pictures of forbidden, secret targets and to transmit the data further. In industrial sites, visitors are typically forbidden to take pictures as well as transmit other kind of information to outside the company. The ban on camera equipment may be secured by making the visitor leave his camera at the reception for the duration of the visit; the camera is returned to the owner when he leaves the premises. This is one way for making sure that forbidden electronic devices are not used inside the company area. A drawback in this solution is that the visitor may be left without his communication device for a long time, which means that he cannot be reached. This kind of policy may lead to further problems, and it may even be impossible to put it in practice. There are many users who must be available nearly all the time, and for whom long interruptions in communications are impossible.

An objective of the invention is to realize the prevention of undesirable functions in a simple, user-friendly way. Another objective of the invention is to prevent and control any disturbing or hazardous situations caused by the operation of a device in a reliable and effective manner.

The objective is achieved so that in the device, there is received a code key for preventing an undesirable function, whereafter the undesirable function is prevented by setting a block for the function by means of the received key.

The invention is characterized by what is set forth in the independent claims. Advantageous embodiments of the invention are described in the dependent claims.

In a method according to an advantageous embodiment of the invention, a function of a portable device is temporarily blocked so that in the device, there is received a blocking key that blocks a certain function, and that the received blocking key is activated in the device in order to prevent said function. The device sending the blocking key can be for instance a computer located at the reception of a company; said computer is used for transmitting a blocking key to the devices of persons visiting the company, and the blocking key can for example prevent camera functions in the device. The blocking key can be transmitted via a wireless, short-range connection in message form, for instance as a short message, or via a cable to be connected to the devices. Thus a device function can be prevented at the initiative of a party external to the device, in a way defined by said external party. According to an advantageous embodiment, the device that received the blocking key yet requests the user to confirm the operation before the received blocking key is activated. Thus an external device or its user cannot block a certain function or functions of a device without the acceptance of the user of said device.

According to an advantageous embodiment, the blocking key is used for blocking a given, undesirable function of the device for a given duration, until the device receives an unblocking key that cancels the blocking key, and the received unblocking key is activated in order to release the device function that was blocked. Also the unblocking key can be received via a wireless, short-range connection, in message form or via a cable. According to an advantageous embodiment, the device requests a confirmation of the user also before activating the received blocking key. Thus, according to advantageous embodiments, the user himself decides whether to block or unblock the functions of his device, so that the user confirms the activating of a key transmitted by an external device. When the unblocking key is activated, it cancels the earlier blocking key and releases the blocked function to work in its normal, original way, as it was working before activating the blocking key.

A portable device according to an advantageous embodiment of the invention includes segments in order to realize the device functions. Moreover, the device advantageously includes means for receiving a blocking key that blocks a given function, and means for activating the received blocking key in the device in order to prevent the function of a given segment thereof. Respectively, the device comprises means for receiving an unblocking key that unblocks the function blocked by the blocking key, and means for activating the received unblocking key in the device in order to release the function that was blocked by the blocking key. Typically the device includes programmable means for processing the blocking key and the unblocking key.

According to an advantageous embodiment of the invention, a given function or functions in a device—which could in the situation at hand cause danger or disturbance or be otherwise undesirable—can be made inoperative at the initiative of an external device. Advantageously the user only needs to accept the block to the function. For example the Nokia Communicator mobile phone (Nokia Corporation, Helsinki, Finland) has a mode where the phone is switched off, but the computer can still be used. For instance in an airplane, it could thus be possible to switch off the phone, but still for instance play the games included in the device. In these cases, however, it is the user who himself deliberately switches off certain functions. Whereas, according to the advantageous embodiment of the invention, the initiative for switching off a function an switching it on again comes from an external party, an external device. In addition, according to an advantageous embodiment of the invention, the external party defines the key details, i.e. which functions are switched off and how the switching off is realized. An additional advantage for the party who sends the blocking and unblocking keys is that the duration of the temporary blocking can be defined by the sender, so that the unblocking key corresponding to the blocking key is transmitted at a desired point of time.

The invention is described in more detail below with reference to the appended drawings, where

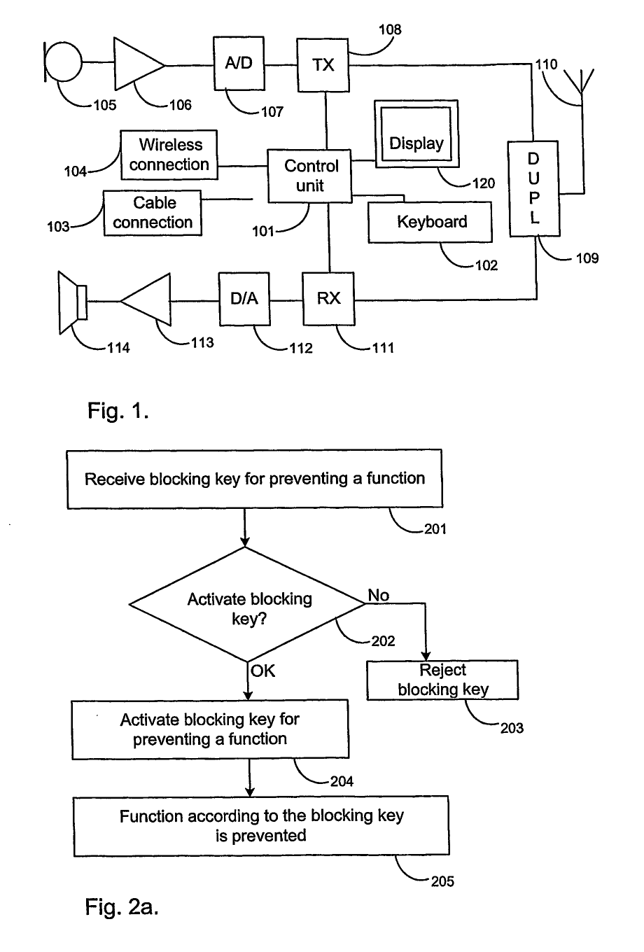

FIG. 1 illustrates a device according to an advantageous embodiment of the invention,

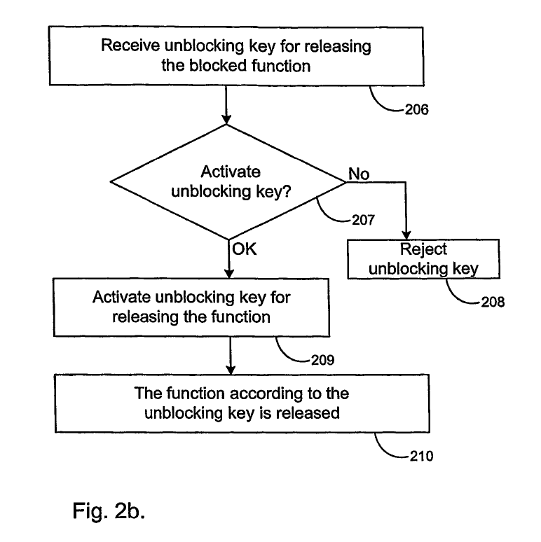

FIG. 2a illustrates a method according to an advantageous embodiment of the invention,

FIG. 2b illustrates a method according to an advantageous embodiment of the invention, and

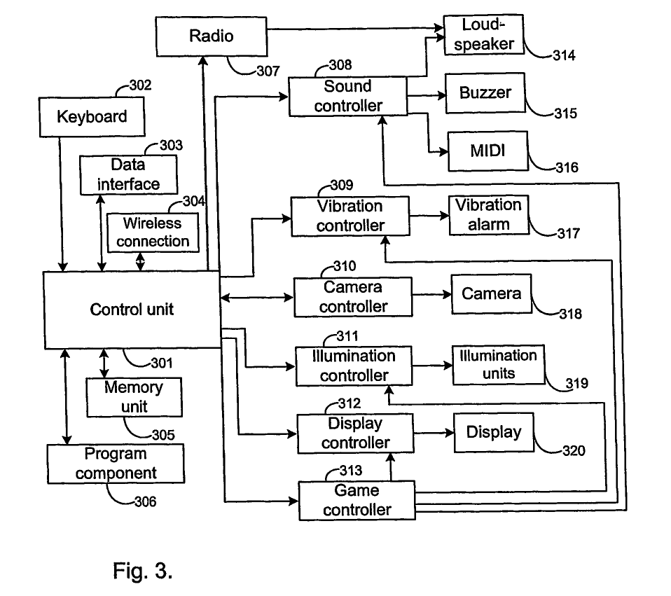

FIG. 3 illustrates a device according to an advantageous embodiment of the invention.

The portable device according to an advantageous embodiment of the invention includes segments for realizing the device functions, means for receiving a blocking key for blocking a given function and means for activating the received blocking key in the device in order to prevent the function of a given segment thereof. In addition, the device respectively has means for receiving an unblocking key for releasing the function that was blocked by the blocking key and means for activating the received unblocking key in the device in order to release the function that was blocked by the blocking key. Activation of an executable block key is typically performed by executing the received program block by using programmable means of a device receiving the block.

FIG. 1 illustrates a portable device according to an advantageous embodiment of the invention, which portable device can receive blocking and unblocking keys. The transmission branch of the device includes a microphone 105, an amplifier 106, an A/D converter 107 whereby analog signals are converted into digital form, and a transmission segment TX 108. The reception branch of the device includes a reception segment RX 111, a D/A converter 112, whereby digital signals are converted into analog form, an amplifier 113 and a loudspeaker 114. The signals entering the device and emitted therefrom pass through an antenna 110 and a duplexer 109, i.e. a transceiver duplexer. The transmission segment TX 108 and the reception segment RX 111 are connected to the duplexer 109 and to the device control unit 101 that takes care of all the device functions.

A device according to an advantageous embodiment of the invention includes means for requesting a confirmation and feeding in the confirmation before activating the received blocking key or unblocking key in the device. In the exemplary embodiment of FIG. 1, to the control unit 101 there is connected a display unit 120 for displaying data, and a keyboard 102 for feeding in data. Typically the device shows on the display 120 a confirmation request in order to activate the key, and waits for the user to feed in the confirmation, which in practice can be for example the selection of the ok-alternative on the keyboard 102. When requesting confirmation in order to activate the received key, the device may, in addition to the confirmation request attract the user's attention for instance by a sound signal.

Various different routes can be used for transmitting data. Typically the device includes means for receiving the blocking key and the unblocking key through a stationary cable connection. This requires that the device is provided with a terminal where the cable can be connected in order to connect the device in a stationary fashion to the device sending the blocking or the unblocking key. A portable device according to an advantageous embodiment of the invention includes means for receiving a blocking key and/or an unblocking key transmitted via a wireless connection. FIG. 1 illustrates a wireless terminal 104, which is typically a short-range connection terminal, for example an infrared interface panel or a bluetooth interface panel. It is also possible to alternatively use a WLAN (Wireless Local Area Network), which is a LAN network where radio-, microwave-, or infrared links take the place of physical cables. WLAN is also known as a Cableless LAN. Typically the device includes in addition or as an alternative also means for receiving the blocking and/or unblocking key transmitted through a messaging service center. In the embodiment of FIG. 1, the messages can be transmitted through air, i.e. wirelessly, for instance from a SMSC, short message service center, in which case for example SMS or MMS messages (MMS, multimedia messaging service) are received through an antenna 110 to a control unit 101, which then guides them to be processed in a message-processing segment. Moreover, some devices can also be used for transmitting for instance email messages or messages according to the SIP (session initiation protocol).

FIG. 2a illustrates a method according to an advantageous embodiment of the invention for blocking a function of a device. In step 201, there is received a blocking key that can be activated in the device, so that it prevents a certain function or functions of the device. Typically the blocking key is an executable block, i.e. a program block to be run. For example at the reception of a company, it is now possible—instead of collecting all mobile phones of the visitors—simply to transmit a blocking key to the visitors' devices for instance for preventing camera functions. Advantageously the device can also be completely switched off by the blocking key until the unblocking key that releases the blocking key is received and activated. Thus for example in a hospital or in an airplane it can be made sure that nobody switches their device on before it is allowed.

In step 202, the user of the device is expected to confirm whether to activate the received blocking key. The user may deny the activating of the received blocking key in his device, in which case the blocking key is rejected, 203, for example deleted. If the user accepts the activating of the received blocking key and feeds in a confirmation for performing the activating command, the blocking key is activated in the next step 204. Thereafter, in step 205, the function or functions defined by the blocking key are prevented. This means that the function in question cannot be used in the device.

FIG. 2b illustrates a method according to an advantageous embodiment of the invention for releasing a blocked function in a device. By using a blocking key, there is blocked a given undesirable function of the device for the duration until there is received an unblocking key, and by activating said unblocking key, the blocked function is released to function normally, in the same way as it was functioning before activating the blocking key. When a function is blocked, i.e. when its use is prevented, as is shown in the illustration of the advantageous embodiment of FIG. 2a, said function can again be released to its normal, original purpose by means of an unblocking key that cancels the blocking. In the embodiment of FIG. 2b, in step 206, in a device where the use of a certain function is temporarily prevented by activating a blocking key, there is received an unblocking key that cancels the blocking key. The unblocking key can be received in the device via a wireless, short-range connection, in messages form, for instance as an email, SMS or MMS message, or through a connecting cable. According to the advantageous embodiment, the unblocking key is transmitted by the same device that earlier transmitted the blocking key. The unblocking key corresponding to a given blocking key, which unblocking key releases a blocked function, is typically transmitted by the same party, because preferably the party who transmitted the function-blocking key also has the authorization to transmit the function-releasing unblocking key. Thus the party transmitting the keys can define how long a given function is kept blocked in a given device. Typically the duration is defined for example on the basis of the time that the device stays in the premises controlled by the key-transmitting party. However, the unblocking key can also be transmitted via a different route than the one through which the corresponding blocking key was transmitted. For instance, the blocking key can be transmitted from a computer to a mobile phone by means of a cable, and respectively the unblocking key can be transmitted from the same computer, or from another device controlled by the same party, as an SMS message to the same mobile phone.

In step 207, in the device there is made a confirmation request for the user before activating the received blocking or unblocking key in the device. If the user does not feed in a confirmation, but denies the activating of the unblocking key, the unblocking key is rejected in step 208. The unblocking key, and respectively also the blocking key, can for a given period be recorded in the short-time memory of the device, from which the unblocking key can according to step 207 be activated somewhat later. Thus it is not necessary to activate the unblocking key Immediately after receiving it. In case the user in step 207 accepts the activating of the unblocking key, the received unblocking key is activated in the device in step 209 in order to release the blocked function. In step 210, the function that was earlier blocked by the blocking key, is again released to function normally, in the original way, in the same fashion as before activating the blocking key. According to an advantageous embodiment, the blocking and unblocking keys are executable program blocks to be run, and they are dealt with by programmable means or program tools.

FIG. 3 illustrates a mobile, portable device according to an advantageous embodiment. The device includes a control unit 301 that takes care of all the functions in the device. In the embodiment of FIG. 3, the suggested data feeding device is a keyboard 302. The data interface 303 is an interface whereby the device can be connected to another device or network. Typically the data interface 303 is for example a counterpiece for a route or a cable connection. Data can be transmitted into the device or out of the device via the data interface 303. The wireless interface 304 is an interface with similar properties as the data interface 303, but in the wireless interface, nothing is concretely connected thereto; the wireless interface 304 to an external device can be realized for instance by applying short-range WLAN, infrared or bluetooth technique. In that case the interface 304 of the device is a panel that can receive and transmit radiation of the described type. In addition, the device includes a memory unit 305. The program component 306 takes care of the following functions: identifying, activating, running, recording and post-use deleting of the blocking and unblocking keys according to the advantageous embodiment of the invention. The executing, running and driving of the program blocks containing the blocking and unblocking keys is carried out by the control unit 301.

In current portable devices, there are integrated various segments that increase the device functions and make them more versatile. According to an advantageous embodiment of the invention, a temporary block can be set for said functions, in case they in certain situations are considered to be disturbing or even dangerous. Let us now observe, by way of example, the segments performing the device functions. In addition to the functional segments and applications connected to portable devices, the users may typically download desired applications in their devices. Thereby there is nearly an unlimited number of various functions of different types that can be obtained in the devices, and these functions are performed either by the portable device or by an external device as a response to a request transmitted by the portable device. The function blocking according to the advantageous embodiment of the invention can also be used for blocking said externally downloaded or externally performed functions. The device illustrated in FIG. 3 includes a radio transmitter 307, the data received by which the user may listen through the loudspeakers. The radio waves received by the radio transmitter 307 may in certain situations be harmful for the environment. In addition, in certain situations even the radio sounds may disturb, wherefore the radio transmitter can according to an advantageous embodiment of the invention be blocked to be temporarily inoperative, and further released to function normally. In practice this can be realized so that data is not transmitted from the control unit 301 to the radio transmitter 307, in which case the device is in a blocked mode. Another alternative is by a blocking key to prevent the current supply to the radio transmitter 307, which again means that the radio transmitter 307 is in a blocked mode.

Typical segments in portable devices for producing sound are components such as a loudspeaker 314, a buzzer 315 or a MIDI (musical instrument digital interface) device 316 that improves a monotonous sound environment. The sounds in the device are controlled by a sound controller 308. If the function to be blocked according to the advantageous embodiment of the invention is a sound function, the sound controller 308 can be set in an inoperative mode, in which case sound commands are not transmitted to the sound-producing components. According to another alternative, the sound-producing components, such as the loudspeaker 314, the buzzer 315 or the MIDI device 316 are set to be inoperative, for example by preventing their current supply. Respectively, the vibration functions of the device, typically a vibration alarm 317 of the battery, are controlled by a vibration controller 309. Also this function can be blocked by temporarily preventing the operation of the vibration controller 309 or the vibration alarm 317 by means of a blocking key.

By means of the camera 318 integrated in the device, images can be recorded in a digital form, and they can be viewed on the display or transmitted further to other devices via connection routes known as such. The operation of the camera is controlled by a camera controller 310. The blocking of these segments has turned out to be important in many situations. According to an advantageous embodiment of the invention, the camera 318 of the device is made inoperative for instance for the duration of industrial visits in order to prevent an unauthorized use of the camera 318. The program component 306 identifies the blocking key according to an advantageous embodiment of the invention, which key is received for example via a wireless interface 304. By means of the control unit 301, the program component 306 processes the received blocking key, and if the user confirms the activating of the received blocking key in the device, the blocking key is activated for instance by performing the commands of the key whereby for example the camera controller 310 is blocked, so that the camera 318 of the device or its functions are not available for the user. The unblocking key releasing the function can be received and activated respectively. Advantageously the party transmitting the blocking key also decides when the respective unblocking key is transmitted.

In the device of FIG. 3, there also are illustrated illumination units 319 that are controlled by an illumination controller 311, a display 320 that is controlled by a display controller 312 and a game controller 313 that can be used for controlling for instance the operation of the buzzer 315 through a sound controller 308, the operation of the vibration alarm 317 through the vibration controller 309, the operation of the illumination units 319 through the illumination controller 311, and the display 320 functions through the display controller 312. Typically the device requests a confirmation from the user for activating the keys by a confirmation request on the display 320. Moreover, on the display there can be shown information regarding the mode of the device, for example by indicating which function or functions are at the moment temporarily blocked, and for example by whom the blocking was performed.

According to an advantageous embodiment of the invention, a certain function or several functions of the device can be blocked by means of a blocking key transmitted from outside the device. Several blocking keys can also be transmitted in succession, in which case the functions are blocked one by one. The blocked functions can be released by means of respective unblocking keys, for instance by releasing all blocked functions or only one blocked function at a time, in a desired order. The unblocking keys for releasing functions can be transmitted in a different order than the blocking keys, and functions can be released according to the unblocking keys in a different order than they were blocked. In the previous specification, there are by way of example described a number of typical functions in which the arrangement according to the invention can be applied. However, the invention can also be applied, within the scope of the invention defined in the appended claims, in other functions, in various devices, and further, the blocking and unblocking keys according to the advantageous embodiment of the invention can be received via various types of routes.

What is claimed is:

1. A method for temporarily blocking a function in a portable device, characterized in that in the device there is received via a wireless connection an executable blocking key for blocking a certain function of the device, and that the received blocking key is activated by programmable means in the device in order to prevent the certain function of the device.

2. The method according to claim 1, characterized in that in the device there is received an unblocking key that cancels the blocking key, and that the received unblocking key is activated in the device in order to release the function of the device that was blocked.

3. The method according to claim 2, characterized in that the blocking or unblocking key is received in the device through a wireless, short-range connection, in message form or via a cable.

4. The method according to claim 3, characterized in that in the device, there is displayed a confirmation request, and that the received blocking or unblocking key is activated in the device as a response to feeding in the confirmation.

5. The method according to claim 4, characterized in that the blocking key is used for temporarily blocking a certain undesirable function of the device for the duration, until there is received an unblocking key, and by activating said unblocking key the blocked function is released to function in the way it functioned before the activation of the blocking key.

6. A portable device containing segments for realizing the device functions, characterized in that the device includes means for receiving via a wireless connection an executable blocking key for blocking a certain function, and programmable means for activating the received blocking key in the device in order to prevent the function of a certain segment thereof.

7. The portable device according to claim 6, characterized in that it includes means for receiving an unblocking key for releasing the function blocked by the blocking key, and means for activating the received unblocking key in the device in order to release the function that was prevented by the blocking key.

8. The portable device according to claim 7, characterized in that it includes means for receiving a blocking key and/or an unblocking key transmitted along a wireless, short-range connection.

9. The portable device according to claim 8, characterized in that it includes means for receiving blocking key and/or an unblocking key of a message-form transmitted through a message service center.

10. The portable device according to claim 9, characterized in that it includes means for displaying a confirmation request and for feeding in a confirmation before the received blocking or unblocking key is activated in the device.

11. The portable device according to claim 10, characterized in that it includes program means for processing the blocking and unblocking keys.

12. The method according to claim 1, characterized in that the blocking or unblocking key is received in the device through a wireless, short-range connection, in message form or via a cable.

13. The method according to claim 1, characterized in that in the device, there is displayed a confirmation request, and that the received blocking or unblocking key is activated in the device as a response to feeding in the confirmation.

14. The method according to claim 1, characterized in that the blocking key is used for temporarily blocking a certain undesirable function of the device for the duration, until there is received an unblocking key, and by activating said unblocking key the blocked function is released to function in the way it functioned before the activation of the blocking key.

15. The portable device according to claim 6, characterized in that it includes means for receiving a blocking key and/or an unblocking key transmitted along a wireless, short-range connection.

16. The portable device according to claim 6, characterized in that it includes means for receiving blocking key and/or an unblocking key of a message-form transmitted through a message service center.

17. The portable device according to claim 6, characterized in that it includes means for displaying a confirmation request and for feeding in a confirmation before the received blocking or unblocking key is activated in the device.

18. The portable device according to claim 6, characterized in that it includes program means for processing the blocking and unblocking keys.
